(19) United States
(12) Patent Application Publication
(10) Pub. No.: US 2026/0183991 A1
(43) Pub. Date: Jul. 2, 2026

(54) Injection Mold Manufacturing Process Using Targeted Atomized Metal Gradients In An Epoxy Matrix

(71) Applicant: Maxwell Robert Rebella, Hartland, WI (US)

(72) Inventor: Maxwell Robert Rebella, Hartland, WI (US)

(21) Appl. No.: 19/429,527

(22) Filed: Dec. 22, 2025

Related U.S. Application Data
(60) Provisional application No. 63/740,887, filed on Dec. 31, 2024.

(51) Int. Cl. B29C 33/38; B29C 33/44; B29C 41/00; B29C 41/04; B29K 63/00; B29K 505/00; B29K 509/02; B29L 31/00

(52) U.S. Cl. CPC B29C 33/3842; B29C 33/3807; B29C 33/442; B29C 41/003; B29C 41/04; B29K 2063/00; B29K 2505/00; B29K 2509/02; B29L 2031/757

(57) ABSTRACT

A method for manufacturing high-performance injection molds using a composite epoxy-metal matrix enhanced with tailored additives. The process employs centrifugal force during curing to create controlled material gradients, concentrating metal and ceramic particles near the mold surface to improve thermal conductivity, hardness, and structural strength.

### CROSS-REFERENCE TO RELATED APPLICATIONS

This application claims priority to U.S. patent application Ser. No. 63/740,887, filed Dec. 31, 2024.

### BACKGROUND OF THE INVENTION

Plastic injection molding is one of the most widely used manufacturing processes for producing plastic components in large volumes. The process involves injecting molten plastic into a premade mold, where it cools and solidifies before being ejected as a finished part. This method is prevalent across industries such as automotive, medical, consumer goods, and electronics due to its ability to produce complex, high-precision parts with consistent quality.

Injection molding is an essential component to modern manufacturing, enabling large-scale production of plastic parts across industries ranging from automotive to consumer electronics. While traditional metal molds offer durability and precision, they are expensive, time-consuming to produce, and often limited in complexity. The high initial costs associated with steel and aluminum molds present a significant barrier for companies and individuals seeking scalable plastic manufacturing solutions. Lower-cost alternatives such as 3D printed and composite molds do exist; however, they typically lack the mechanical performance necessary for anything beyond prototyping. Existing research on composite materials for mold fabrication is well-documented, particularly in the study of epoxy additives to enhance mechanical and thermal properties while reducing costs. Despite this, composite molds are still largely limited to low-cycle applications in industry.

The high upfront cost of aluminum and steel molds makes injection molding inaccessible to many. Building these molds requires specialized industry knowledge and expertise, with lengthy CNC milling times that can take days or even weeks to complete. This complex, time-consuming process is inefficient and limits innovation for smaller companies needing rapid prototyping or quality lower-cost production options. Traditional injection molds require expensive CNC-millable metal, while 3D-printed or epoxy-only molds lack durability, hardness, and thermal stability for repeated use.

An injection molding machine consists of three main components: the injection unit, the mold, and the clamping unit. Plastic pellets are heated and injected from the injection unit into a precisely machined mold cavity, which shapes the material as it cools. The mold itself plays a critical role in determining the final part's quality, dimensional accuracy, and cycle time. Traditional injection molds are manufactured using high-precision CNC machining, electrical discharge machining (EDM), and other advanced reductive manufacturing methods, requiring expensive tooling materials and skilled labor. Last, the clamping unit reciprocates to withdraw the molded part from the void space between molding plates, and to engage the molded part with ejector pins carried by the clamping unit, to dislodge the molded part from the mold.

To manufacture an injection mold, several critical components must be incorporated to ensure proper functionality and efficiency. The mold cavity and core define the final shape of the part, while sprues and runners guide molten material from the injection nozzle into the mold. Gates control the flow of plastic into the cavity, influencing part quality and cycle time. Ejector pin holes house ejector pins, which push the molded part out of the cavity after cooling. Cooling channels regulate temperature to minimize warping and reduce cycle times. Additionally, vents allow trapped air to escape, preventing defects like burns or voids. Normally these features would be removed from the metal mold via CNC machining or reductive methods, but in this method the geometry is 3D printed and then removed after curing.

The largest cost factor in traditional mold manufacturing is not the raw material itself but rather the machining and labor-intensive manufacturing process. CNC machining of molds requires highly skilled operators and multiple stages, including roughing, finishing, heat treatment, and surface polishing. Depending on complexity, mold fabrication can take weeks or even months, significantly increasing initial upfront costs. Surface treatments such as nitriding, anodizing, and polishing further add to production expenses. These high initial costs make injection molding less attractive for medium volume applications, including smaller manufacturers and startups.

To reduce mold fabrication costs, alternative methods such as composite molds, and 3D-printed molds have been explored. However, these alternatives lack the mechanical durability, hardness and thermal resilience required for high-pressure injection molding. Other composite materials struggle to maintain dimensional stability and structural integrity under the repeated thermal and mechanical stresses of injection molding. Similarly, while 3D-printed molds offer a rapid and cost-effective alternative, most printable materials lack the required strength, heat resistance, and wear tolerance to withstand repeated molding cycles without warping, cracking, or degradation.

Another labor intensive aspect of injection molding is the configuration and placement of ejector pins. A 2-plate mold is a common design consisting of two primary halves: the cavity plate (stationary side, attached to the injection unit) and the core plate (moving side, attached to the ejector system). These plates separate along the parting line during mold opening. Mold inserts are removable components—typically the cavity insert and core insert—that fit into pockets within these plates and define the actual geometry of the molded part. Swapping inserts allows manufacturers to produce different part variations using the same mold base, reducing tooling costs and setup time compared to building entirely new molds. This is particularly useful for family molds or low-to-moderate volume production where part designs share similar overall dimensions but vary in details like features, sizes, or logos.

Ejector pins reciprocate to remove the solidified plastic part from the core after cooling. They are typically cylindrical rods made from durable materials like hardened steel. In a 2-plate mold, ejector pins are housed in the moving half (core side), passing through holes in the core plate and insert to contact the part. Their design and operation ensure the part is ejected without deformation, sticking, or surface defects, while maintaining cycle efficiency.

During injection, the mold is closed, and molten plastic fills the cavity formed by the inserts. Ejector pins remain retracted within the core, flush with or slightly below the molding surface to avoid interfering with material flow. After the part cools and solidifies, the clamping unit separates the plates along the parting line. The part may stick to the core due to shrinkage and undercuts.

The machine's ejector system (hydraulic or mechanical) advances the ejector plate, pushing the pins forward into the mold cavity. The pins apply uniform force to strategic points on the part, dislodging it from the core. This stroke is controlled (e.g., 5-20 mm, depending on part depth) to fully eject the part without excessive force that could cause breakage or marks. Once the part is ejected (often falling into a conveyor or being removed by a robot), the ejector plate retracts, pulling the pins back to their initial position. The mold closes for the next cycle.

Ejector pins are positioned during mold design and fabrication, based on the part's geometry, material, and ejection requirements. Designers place pins in the ejector plate to align with holes drilled through the core plate and insert. Ejector pins may be positioned at ribs, bosses, or thick sections for maximum force without damaging thin walls or cosmetic surfaces (to avoid visible marks). Ejector pins may include features like flats or keys to prevent rotation on curved surfaces. Pins are secured in the ejector plate via retainers, with heads fitting into counterbores for stability.

Switching to a new mold often requires repositioning ejector pins to match the updated geometry, as ejection points must align with the new part design to ensure uniform force and defect-free ejection. It is desirable to streamline repositioning ejector pins to save costs and minimize downtime.

### SUMMARY OF THE INVENTION

This invention seeks to address the cost and accessibility challenges of injection molding. The proposed methods significantly reduce the need for expensive CNC machining, enabling rapid mold production without the requirement for highly specialized manufacturing expertise. By lowering the initial investment required for injection molding, this technology makes small and medium-scale manufacturing more accessible to businesses, entrepreneurs, and research institutions that would otherwise be unable to afford traditional metal molds.

An advanced mold manufacturing method for producing durable, high-performance composite injection mold is disclosed. The process utilizes a 3D-printed mold structure to define precise mold features—including the mold cavity, sprue and runner geometry, and conformal cooling channels—which are difficult and costly to produce with traditional tooling. The internal volume of this printed mold is filled with a customized mixture of epoxy resin and performance-enhancing additives such as atomized metal powders, carbon fibers, and ceramic particles. During curing, the mold is subjected to controlled centrifugal force, which induces a material gradient within the epoxy matrix by redistributing higher-density constituents toward desired zones. This gradient tailoring enables the mold's mechanical and thermal properties—such as strength, hardness, and heat resistance—to be optimized for specific application requirements while minimizing material costs. Once the composite has fully cured, the original 3D-printed structure is removed, leaving behind a robust mold that closely replicates the desired geometry and integrates advanced thermal and structural features. The result is a cost-effective alternative to traditional metal molds that delivers comparable performance and greater design flexibility, especially for low-to-medium volume injection molding applications.

One process uses cold casting techniques to create durable, precision molds at a fraction of the cost and time of traditional metal molds. By combining high-temperature-resistant epoxy and atomized metal around a 3d printed model, extensive CNC machining is minimized, allowing production of high-quality molds quickly and affordably, making injection molding accessible to startups and small businesses.

In a preferred process, epoxy and metal powder are combined around 3D-printed forms; once fully cured, this composite achieves the durability, hardness, and thermal resilience of traditional metal molds—without the high upfront costs. Once fully cured, this composite achieves the durability, hardness, and thermal resilience of traditional metal molds.

A wide variety of useful items across different industries can be produced, such as precise plastic components for consumer electronics, automotive, aerospace, and industrial applications. In the medical field, the present invention can produce molds for custom prosthetics, orthotics, and dental implants.

### BRIEF DESCRIPTION OF DRAWINGS

FIG. 1 is a perspective view of a centrifuge assembly for use with the present invention;

FIG. 2 is a perspective view of a mold housing for positioning within the centrifuge assembly of FIG. 1;

FIG. 3 is a perspective view of a mold enclosure assembly carrying an exemplary part geometry for molding;

FIG. 4 is a perspective view of a mold housing top;

FIG. 5 is a perspective view of an end result mold insert, viewed from the cavity side;

FIG. 5A is a view of the mold insert of FIG. 5, showing void channels left by the production process;

FIG. 6 is a perspective view of a mold base assembly;

FIG. 6A is a side view of the mold base assembly of FIG. 6;

FIG. 6A′ is a closeup side view of portions of the mold base assembly of FIG. 6A;

FIG. 6B is a side view of an ejection base and an associated comb structure;

FIG. 6B′ is a closeup side view of portions of the ejection base of FIG. 6B with an associated comb structure;

FIG. 6C is a side view of an ejection base cover;

FIG. 7 is a side view of an ejector pin with a shaped end;

FIG. 8 is a perspective view of an ejection system with a single pin, with a cover to the system removed;

FIG. 9 is a perspective view of the ejection system of FIG. 8, including a cover to the system.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The present invention is directed to a manufacturing process for producing composite injection molds. This process introduces a novel approach that combines multiple techniques to achieve efficient, cost-effective, and high-performance mold production. The invention includes a method, as well as components, with an emphasis on improving traditional mold-making practices.

In an initial step of the method, a part planned for production by injection molding is analyzed, for instance in a suitable software program, to determine if the part planned would be optimally produced using either a 2-plate, 3-plate, or another suitable molding method. Additionally, the planned part for injection molding can be modified by including necessary components, such as a 2% increase in size and adjustments to the geometry to improve mold flow and prevent overhangs or inaccessible areas.

Next, the planned part can be split into sides to be molded, for instance creating core and cavity sides for a typical 2 plate mold. Next, preferred components used during the injection molding process, including the conformal cooling channels, sprue geometry, injection pin holes, and the mold assembly pin holes can be planned. The final mold design can be analyzed to confirm proper mold flow, adequate space, and durability.

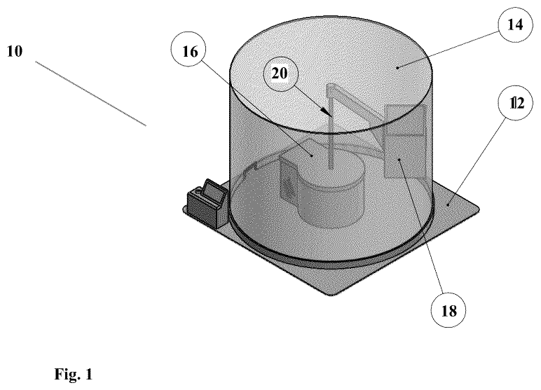

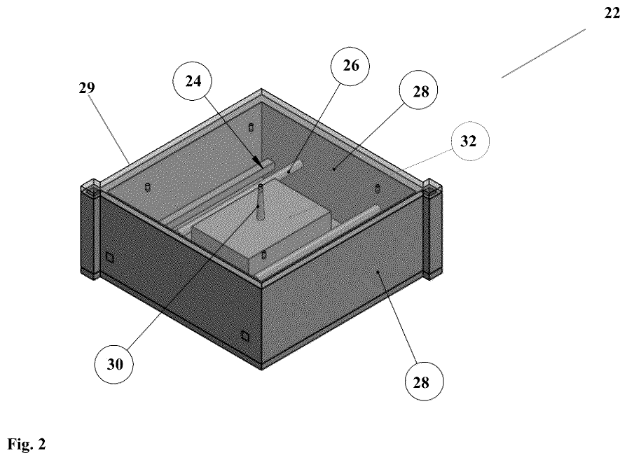

Referring now to FIG. 1, a perspective view of a centrifuge assembly 10 for use with the present invention is shown. Centrifuge assembly 10 can optionally be provided with a base 12 for stability, a shield 14 for safety, and a base top 16 for shielding the centrifuge during operation. The centrifuge assembly 10 enhances the strength and precision of cold-cast molds while also reducing production costs. In a preferred embodiment, a motor 16, preferably either a programmable base/face-mount speed-control motor or brushless DC (BLDC) motor, is used to provide relatively high torque and rotational speeds that are desirable for effective operation. Motor 16 is precisely speed-controlled, ensuring optimal distribution of the cold-cast mixture of atomized stainless steel and high-temperature epoxy used in the operation. During operation, motor 16 rotates centrifuge shaft 20 that carries centrifuge mold housing repository 18 at a relatively distant radius to enhance centrifugal forces. Centrifuge mold housing repository 18 carries a mold (see FIG. 2), itself carrying material to be centrifuged. Denser stainless-steel particles entrained in the material to be centrifuged are pushed outward, creating a gradient of material composition that reinforces high-stress areas while minimizing material usage in low-stress regions. This targeted strengthening reduces the amount of expensive metal powder required and ensures the mold retains durability and heat resistance where needed most.

Referring now to FIG. 2, a perspective view of a mold housing 22 for positioning within centrifuge mold housing repository 18 of the centrifuge assembly 10 of FIG. 1 is shown. The mold housing 22, preferably 3D printed, is used in the cold-cast mold-making process as a structure where cold-cast mixture is poured. Sidewalls 28 and a floor (not visible) form mold housing 22, in addition to top cover 29 which is depicted in FIG. 2 as transparent so that inner components are visible.

The mold housing 22 is digitally designed for 3D printing with standard injection molding principles in mind, such as consistent wall thickness, proper load paths, cosmetic surface placement, and draft angles of approximately 1-2 degrees to aid part ejection. Features like ribs may be added to reinforce thin walls, and ideal gate locations are selected to promote uniform flow and minimize defects such as warping or air trapping. Round or trapezoidal runners are modelled based on part geometry and flow dynamics. Venting channels are incorporated at appropriate locations to allow air to escape during injection, preventing voids or short shots.

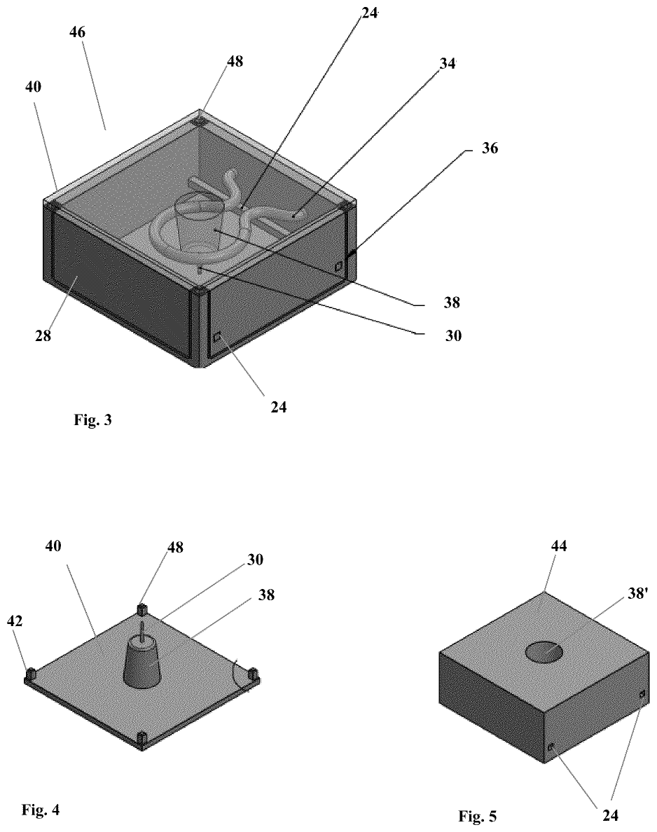

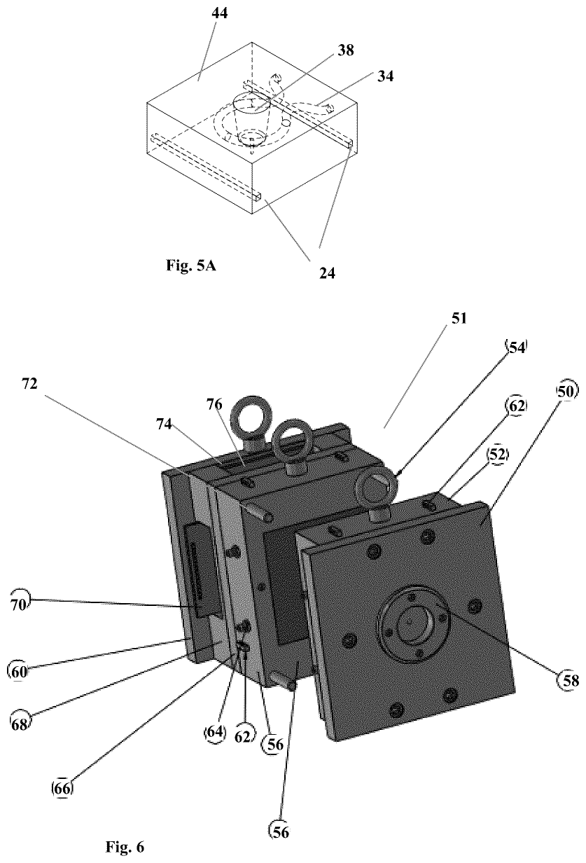

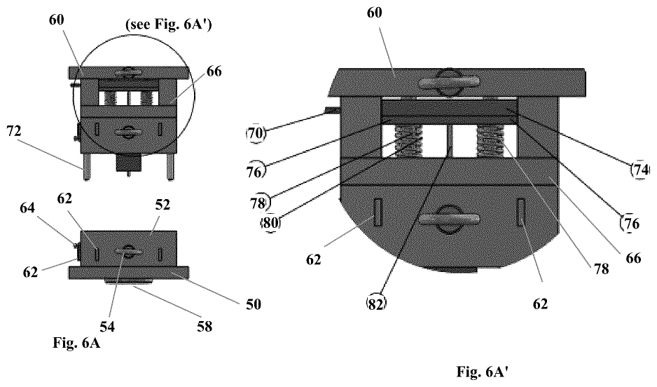

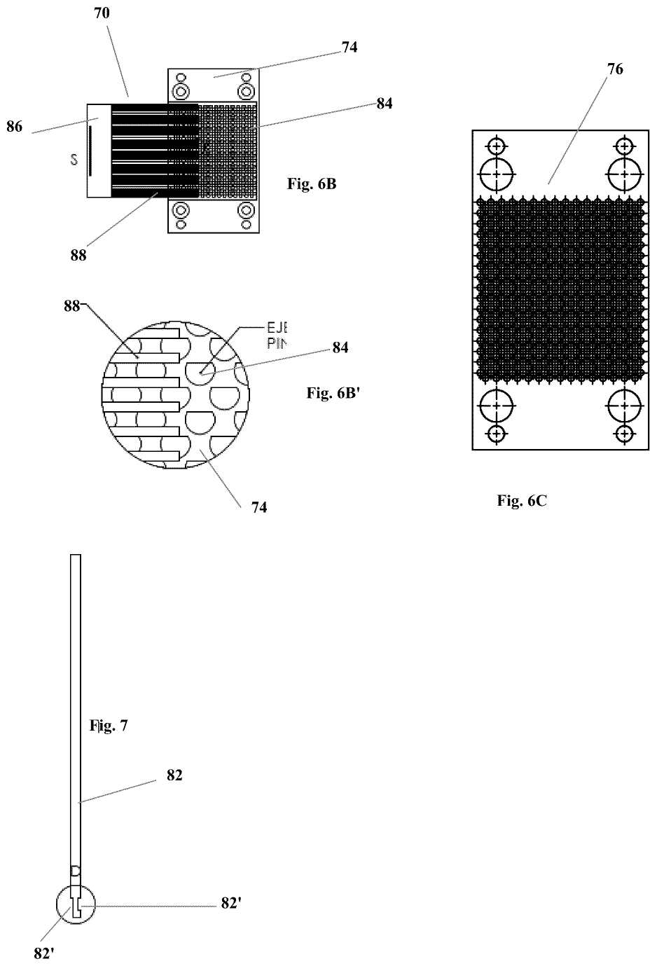

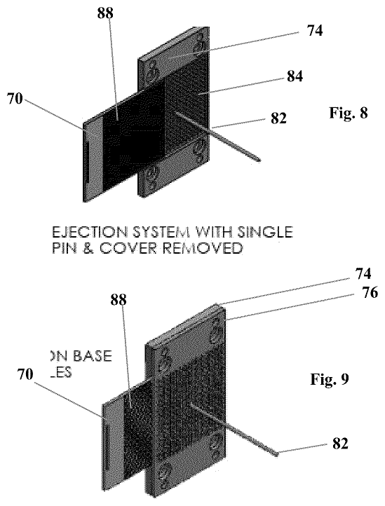

Both the external enclosure of mold housing 22 and all internal mold geometry are preferably 3D printed using a high-rigidity, high-resolution resin. A precision 2D resin printer (such as a Formlabs 4) may be used, offering ±25 Mm accuracy and a minimum layer resolution of 10 Mm. This precision enables the printing of complex internal structures, including conformal cooling channels 34 (see FIG. 3), fine ejector pin housings (see FIGS. 6-9), and geometrically complex sprue and runner systems. Resin printing may be used over Fused Deposition Modeling (FDM) for better resolution, accuracy, and precision, as well for a lack of visible layer lines. The cavity and core geometry for the final plastic part (see FIGS. 4-5) is also printed directly, ensuring dimensional accuracy and tight tolerances.

The 3D-printed mold structure for instance shown in FIG. 3 may include breakaway points to enable easy removal of the printed plastic enclosure after the composite mold cures. Structural connection points are modelled to hold internal components, such as mold inserts or cooling tube placeholders, in secure alignment. Conformal cooling channels 34 are printed directly into the enclosure, following the shape of the part cavity for efficient heat extraction during molding. Space for ejection pin alignment in the form of mold insert pin channel 24 is printed into the base or side walls of the mold, and optional venting holes or slits may be included where air evacuation is necessary.

Referring to FIGS. 2 and 3, the printed geometries serve as a negative cavity into which a mixture of epoxy, atomized metal, carbon fiber, and ceramic additives is poured. During the curing process, the mold is subjected to centrifugal force using centrifuge assembly 10 (see FIG. 1), causing material gradients to form in response to density differences. Heavier particles (such as metal) migrate outward, forming regions of higher strength and thermal conductivity, while lighter materials concentrate near the core. These gradients are controlled by adjusting spin speed, curing time, and mixture composition. Once cured, the 3D-printed structure is broken away, leaving behind a composite mold with hardened, functional geometry.

All printed features are dimensioned and aligned with industry tolerances required for high-quality plastic injection molding, and the internal geometry is reinforced by the composite matrix to withstand the mechanical and thermal loads of repeated molding cycles. The resulting mold is significantly faster and cheaper to produce than traditional machined steel tools while maintaining performance suitable for low to mid-volume production.

Referring again to FIG. 2, within mold housing 22, a speculum pin 24 is provided, along with tube 26, and sprue 30 which is held by sprue base 32. These features are to create void spaces in the resulting mold. Sprue 30 is channel through which, during the molding process described later, liquid is introduced into the interior of mold housing 22. Once 3D-printed material is dissolved, the hardened mold reveals components that will ultimately become cavities, cooling channels, and sprue geometry needed for injection molding. A variety of complex designs, allowing for intricate part shapes, detailed cooling channels, and precise sprue layouts can be used.

For use with a modular mold base, mold insert pin channels 24 are printed into the bottom surface of the mold inserts 22 and 46. These channels 24 accept locking pins from the mold base system (described later), enabling tool-free mounting and dismounting of inserts in the injection molding process. This modularity allows rapid switching between molds on the same press without requiring a full teardown.

Referring now to FIG. 3, a perspective view of a mold enclosure assembly 46 carrying an exemplary part geometry 38 for molding is shown. Mold enclosure assembly 46, preferably 3d printed, receives a poured epoxy-metal matrix (not shown). Mold enclosure top 40 is then positioned atop mold enclosure assembly 46, with mating corner tabs 48 securing top 40 to sidewalls 28. FIG. 4 is a bottom perspective view of mold housing top cover 40. As pictured, mold enclosure assembly 46 is for the cavity side of a 2-plate mold insert. The opposing core side would have protruding part geometry rather than an intruding geometry as shown in FIG. 3.

In the illustrated embodiment, mold enclosure assembly 46 is created with mold insert pin channels 24, conformal cooling channels 34, and sprue and runner geometry 30. These components can all be tailored in accordance with the desired end product of the injection mold. Once the epoxy-metal matrix is cured, the plastic shell of mold enclosure assembly 46 can be removed, facilitated by break away points 36.

In use, mold housing 22, and separately mold enclosure 46, are placed in the centrifuge assembly 10 of FIG. 1, particularly in the centrifuge mold housing repository 18, and subjected to centrifugation.

Once cured, the 3D plastic is removed, leaving the remaining composite mold insert 44 as shown in FIG. 5, a perspective view viewed from the cavity side, and FIG. 5A, that same mold insert 44 shown transparently, so that mold insert pin channels 24 and conformal cooling channel 34 (void channels left by the production process) can be seen within mold insert 44.

In an exemplary embodiment of the present invention, process steps may include the use of atomized metal, less than 50 micrometers in diameter. In one embodiment, 30 μm stainless steel can be used. Ultra-high temperature resistant epoxy may be used (for instance epoxy capable of withstanding 320° Celsius before loss of shape or strength).

In use, mold housing (or mold enclosure assembly) 46 is a rigid containment system designed to align and stabilize the 3D-printed model, all other components, and hold the cold casting material (not shown) in place while the cold casting material cures. Mold insert 44 is then created which meets the dimensional requirements of the molded part.

Next, a high torque centrifuge assembly 10 (see FIG. 1), preferably capable of 10,000 rpm, and a torque rating enough to manage the cold cast insert is used to achieve the targeted distribution of atomized metal within the mold 18.

Next, the mold components and outer mold enclosure shown in FIGS. 2-5 can be 3D printed, using ultra-high-detail resin printers to increase precision as much as possible. The mold components are then assembled to complete the mold enclosure 46.

A cold-cast mixture is then prepared, comprising preferably a mixture of atomized metal powder (e.g., in a preferred embodiment, 30-micron atomized stainless steel powder), a binder (e.g., in a preferred embodiment a high-temperature resin), and a hardener. In a preferred embodiment an effective mixture is 50% metal powder, 43% epoxy type A, and 7% epoxy hardener ratio, although the composition of the mixture, and the ratio of components may vary based on user preference, type of epoxy and centrifuge use.

The composite material used in the mold is formed from a carefully balanced mixture of a high-performance epoxy resin and several structural additives, each contributing to the thermal resistance of the final molds, mechanical strength, and overall durability. The base matrix is composed of an ultra-high-temperature epoxy resin, which functions as the binder that encapsulates and locks together the higher-performance additives. This resin is the rate-limiting material in the composite: it determines the thermal ceiling and compressive performance of the mold under injection pressure and heat. It is essential that the epoxy selected has a high compressive modulus and ultimate compressive strength. These properties ensure the mold can resist deformation under the intense clamping pressure of the injection molding machine, which typically ranges from 2 to 5 tons per square inch depending on part size and complexity. The compressive modulus measures the ability of the mold to retain shape under sustained load, while the ultimate compressive strength dictates the breaking point under extreme pressure.

For development and prototyping, MAX HTE epoxy resin from “The Epoxy Experts” has been used due to its optimal balance between availability, cost, and performance. This resin offers a Shore D hardness of 95 and compressive strength of approximately 15,000 psi at 25° C., making it suitable for withstanding multiple injection cycles without significant wear or deformation. For a typical mold composition—20% MAX HTE epoxy, 60% atomized stainless steel (44 pm), 7% zirconia powder (ZrO2, 50 pm), and 13% chopped carbon fiber (1-3 mm)-cast at 5,000 RPM for 240 seconds (8-inch radius), the resulting mold demonstrates a gradient concentration of 33.4% additive material per inch depth. This translates to a surface hardness of 44.3 HRC at the cavity face, with an ultimate compressive strength of approximately 572 MPa. With higher ceramic loading, thermal resistance of up to 575° F. has been achieved, allowing these molds to support a broad range of injection molding polymers including high-temp materials such as glass-filled nylon and polycarbonate. Dimensional precision of the cavity features remains within ±30 pm, primarily governed by the resolution and accuracy of the high-precision 3D printed mold cavity. For reference, printers such as the Formlabs Form 4B with 10 pm resolution and ±25 pm tolerance is used to define the mold geometry.

This mold configuration yields an estimated cycle life of approximately 95,000 to 100,000 full injection molding cycles before significant degradation in thermal or structural properties. By contrast, 6061 aluminum molds typically last between 10,000-30,000 cycles and are prone to deformation under high clamping forces. P20 tool steel molds, while highly durable (100,000-1,000,000+ cycles), are orders of magnitude more expensive to produce due to machining and labor costs. Additively manufactured polymer molds (e.g., SLA or FDM) without reinforced composites rarely exceed 200-500 cycles before thermal breakdown or warping. Even traditional filled epoxy molds, while capable of several thousand cycles, lack the performance gradient achieved through this centrifugal method, and typically degrade well before 10,000 cycles under standard injection molding conditions.

Atomized metal powder improves the composite's hardness and ultimate compressive strength. Stainless steel is preferred for its high performance in these categories, though other metals such as aluminum or copper can be used based on the required mold properties. The particle size of the atomized metal has not shown significant influence within tested bounds, but 320 mesh (approximately 44 Mm) stainless steel powder is commonly used due to widespread availability.

Thermal resilience of the mold is enhanced through ceramic additives, primarily zirconia (ZrO₂) powder, which improves the composite's resistance to thermal degradation at elevated temperatures. This is advantageous when molding plastics with high injection temperatures. Standard epoxies begin degrading around 350-400° F., but incorporating zirconia can extend the composite's heat tolerance to approximately 465-575° F. This broadens the range of thermoplastics that can be used with the mold. Aluminum oxide powder offers superior performance but can be more expensive.

To further enhance structural performance under load, chopped carbon fiber (CF) strands are included in the mix. These increase the compressive modulus and resistance to deformation under injection clamping forces. Carbon fiber strand length is typically in the 1-5 mm range. Longer strands (around 5 mm) provide superior reinforcement but are better suited to molds with simple internal geometries. For more complex mold shapes with finer internal channels or features, shorter strands are preferred to maintain flowability and avoid clogging during casting.

The precise ratios of each component vary depending on the desired outcome. For molds requiring a balance of all performance factors, a formulation using 20% epoxy resin (MAX HTE), 60% stainless steel powder (44 Mm), 7% zirconia powder (50 Mm), and 13% chopped carbon fiber (1-3 mm) has been effective when spun at 5000 RPM for 240 seconds using an 8-inch mold radius. For applications needing higher thermal resistance and compatibility with high-temperature plastics, a different mixture of 20% epoxy, 45% stainless steel, 20% zirconia powder, and 15% carbon fiber has shown optimal results at 4000 RPM for 300 seconds. For low-cost or lower-cycle applications, a composition of 52.5% epoxy, 40% stainless steel, and 7.5% zirconia has been tested, with spinning at 5000 RPM for 400 seconds to adequately concentrate the additives toward structural regions.

Formulations are not fixed and do not limit the scope of the invention. They serve merely as tested examples of how varying the ratio of components and adjusting centrifugal parameters can achieve different performance objectives. Higher epoxy content reduces material cost but lowers thermal and mechanical performance. Increasing zirconia improves thermal tolerance and expands the types of plastics that can be molded. Additional carbon fiber raises stiffness and compressive resistance, enabling the mold to withstand higher clamping pressures. A greater proportion of atomized metal improves hardness, thermal conductivity, and mechanical strength.

Furthermore, greater centrifugal force (higher RPM or longer spin times) improves additive migration and material gradient formation, reducing the amount of additives required to achieve similar performance in critical mold regions. This allows users to reduce costs without sacrificing strength or durability where it matters most.

The invention is not limited to a specific composition and may include any thermally and mechanically capable epoxy system combined with metal, ceramic, and fiber additives suited to the molding requirements of a specific plastic part.

Once the composite material has been mixed to the desired ratios, it is prepared for casting into the mold assembly. The mold geometry—containing all injection features such as the cavity, gates, runners, cooling channels, and ejector pin slots—is first securely positioned within the 3D-printed mold enclosure. The enclosure includes built-in registration and breakaway points to both maintain the internal geometry's alignment and allow for clean removal of the plastic enclosure after curing.

The composite mixture is prepared using standard mixing equipment and a precision scale to ensure accurate measurement of epoxy and all additives. The components are mixed thoroughly until a uniform, viscous consistency is achieved. This mixture is then carefully poured into the mold enclosure, fully surrounding and engulfing the internal mold geometry. Due to the high viscosity of the composite, it is necessary to displace air pockets trapped within the structure during the pouring process. This is accomplished by vibrating, pounding, or gently shaking the mold enclosure for approximately 5 to 10 minutes, which brings larger air bubbles to the surface and helps the mixture settle into fine internal features.

The cold-cast composite is then poured into the outer mold enclosure 46. Once filled, a leveling tool—such as a straightedge, scraper, or painter's smoothing blade—is used to flatten the surface of the poured composite. This ensures a clean mating interface for the enclosure's top, which is then installed and sealed tightly. The design of the enclosure allows for consistent pressure distribution during curing and supports structural integrity under centrifugal loading.

Preferably, outer mold enclosure 46 is placed into a vacuum chamber (not shown) for a sufficient period time to remove enough trapped bubbles. Prior to the centrifugal casting step, it is highly recommended—but not strictly required—to place the filled mold into a vacuum chamber for 30 minutes to 1 hour. The vacuum degassing process takes advantage of the negative pressure differential between the external environment and any internal air pockets trapped in the viscous epoxy mixture. As pressure is reduced, air bubbles expand and are encouraged to rise to the surface and escape, significantly reducing voids and improving the uniformity and structural integrity of the final mold. This step is especially beneficial for molds with complex geometries or deep cavities where air may become trapped and harder to remove through manual agitation alone.

Next, the molds are sealed and placed into centrifuge mold insert repository 18 of the centrifuge assembly 10, preferably with the parting surfaces of the mold facing outwardly. The centrifuge assembly 10 is then operated, with the RPM and total time of centrifugation varying according to epoxy and metal concentrations as well as desired gradient/distribution of metal atoms.

The orientation of the mold during this stage affects the gradient distribution when subjected to centrifugal force. For centrifugal casting, in a preferred embodiment molds are aligned such that the region intended to withstand the highest mechanical and thermal loads—typically the mold cavity and runner areas—is positioned outwardly, furthest from the axis of rotation of centrifuge shaft 20 (FIG. 1). When spun, the heavier additives (such as atomized metal and ceramic powders) contained within mold housing 22 and mold enclosure assembly 46 migrate radially outward, concentrating in the planned load-bearing zones. The carbon fiber, depending on its density and interaction with the resin, may partially orient or distribute more uniformly depending on strand length and the specific composite mixture.

By adjusting the position of the mold relative to the spin axis of centrifuge shaft 20, the user can tune the performance gradient—ensuring denser, stronger material accumulates where thermal and clamping stresses are greatest, and lighter, less thermally demanding regions remain closer to the rotational center. This technique enables the creation of molds with spatially tailored properties, improving performance while reducing overall material usage and cost.

Optionally after centrifugation, the mold enclosure assembly 46 is removed from the centrifuge assembly 10 and is preferably placed in a pressure chamber at an acceptable pressure (e.g., 60 psi) to cure, typically for 24-30 hours (not shown). Optionally, following pressure curing, mold enclosure assembly 46 is heat treated to epoxy manufacturer specifications, for instance in a conventional oven (roughly 140F for 2 hours) to increase overall mold hardness (not shown).

Post-curing finalizes the material properties of the molds and ensures long-term structural and thermal performance. Once the molds have been centrifugally cast and removed from the centrifuge assembly 10, they are left to cure at room temperature, preferably for 24 hours (more or less) for the epoxy matrix to reach an initial fully-cured state; however, a duration of 36 hours may be preferred to ensure complete crosslinking throughout the bulk of the molds, particularly in areas of higher additive concentration where local thermal conductivity may affect cure rate.

During this period, the mold is preferably placed in a pressure chamber (not shown) and held at approximately 60 psi. This step advantageously reduces the volume and impact of any air pockets that may have been introduced during the filling or mixing stages. The applied pressure compresses residual air to a near-negligible level, minimizing the formation of internal voids or surface imperfections that could affect mold fidelity, strength, or surface finish. This precautionary pressure curing improves both mechanical consistency and dimensional precision, especially in molds with fine geometry or intricate cavity details.

Environmental conditions during post-curing do not require strict climate control; standard indoor temperature and humidity are sufficient. However, the curing environment should remain stable and free from dust, excessive vibration, or moisture, as these could impact the integrity of the mold surface or cause uneven curing in more sensitive areas. Once the curing window has passed, the mold can be safely demolded and inspected for surface quality, internal voids, and final dimensional accuracy before being installed into a mold base or used directly in a molding press.

Upon completion of the curing process, the mold assembly is subjected to a demolding operation wherein the 3D-printed plastic enclosure and internal sacrificial geometry are removed to expose the final mold structure. The removal process results in a solid mold comprising a cavity that is a negative representation of the original embedded geometry. This negative cavity is configured to receive molten thermoplastic material during the injection molding process, forming a final molded part that conforms to the original CAD-designed geometry. To finalize the mold production, heat and water, and a dissolution solution can be used to soften and remove remaining 3D-printed components, leaving behind hardened molds with spaces for plastic injection, cooling channels 34, and connecting holes.

The external enclosure is removed by mechanical separation at intentionally integrated breakaway regions formed during the additive manufacturing step. These regions, typically constructed as weakened zones or notched features in the enclosure, facilitate controlled fracture and separation using standard tools such as a flathead screwdriver inserted into a designated recess. This design enables the enclosure to be removed without imparting damage to the mold cavity or underlying composite structure.

For the removal of the more complex internal features—such as runners, gates, conformal cooling channels, ejector pin cavities, and flow geometries—a solvent-based extraction method is employed. The mold is submerged in a bath of Dipropylene Glycol Methyl Ether (DPM), selected for its high solvency strength, low volatility, and relatively low toxicity compared to traditional solvents used for photopolymer breakdown. The DPM solvent is capable of dissolving the photopolymer resin material without degrading or compromising the structural integrity of the cured composite mold.

To enhance the efficiency of the solvent action, the bath may be heated to approximately 150° F. (65° C.). This temperature has been empirically determined to increase the rate of dissolution without adversely affecting the composite matrix. The mold is typically left immersed in the solvent for a period ranging from 6 to 12 hours, depending on the volume and complexity of the internal printed features.

The removal method is primarily solvent-based, although minor mechanical agitation or fluid circulation may be used to expedite resin dissolution and ensure complete clearing of internal channels. Thermal softening may also be optionally applied, but is generally avoided unless deemed necessary, as it may compromise fine geometries or surface finishes. Following the dissolution and removal of the sacrificial resin components, the resulting mold exhibits an internal cavity with precise geometry, embedded cooling channels, and optimized material gradients achieved during centrifugal casting.

The completed mold structures are now a monolithic, high-performance tool with non-uniform material composition tailored for injection molding applications. The geometry and material distribution within the mold cavity are specifically configured to withstand thermal and mechanical stresses encountered during molding operations, while enabling accurate and repeatable formation of thermoplastic parts.

To mitigate the occurrence of flash during the injection molding process, micro air relief channels may be manually added to the mold cavity surface using a precision razor blade guided along a straightedge. These channels typically consist of 1 to 3 shallow, linear indentations extending from the edge of the part geometry to the outer boundary of the mold face. Each channel is approximately 10 microns in depth and width, allowing trapped air to escape during the injection phase without permitting polymer flow. This controlled venting reduces internal air pressure buildup and ensures full cavity fill without compromising the parting line integrity. By relieving air in this manner, the risk of flash—excess plastic seeping into unintended gaps between mold halves—is significantly reduced. These micro-vents are especially effective in molds lacking dedicated air release systems and serve as a simple but effective solution for maintaining part quality.

The resulting composite molds produced through this gradient-based centrifugal casting process exhibit a unique combination of mechanical strength, thermal resilience, dimensional precision, and longevity that significantly surpasses other composite and additive-manufactured mold options, while offering a substantial reduction in cost compared to traditional metal molds.

Following production of molds, referring now to FIGS. 4 and 5, perspective views of a mold housing top 40 and mold insert 44, viewed from the cavity side, are shown. These forms result from the previously described process and apparatus. Referring in particular to FIG. 4, an exemplary part geometry 38, communicatively coupled with sprue 30 is carried by a mold housing top surface 40. Attachment tabs 42 and mating corner tabs 48 are provided.

Referring now to FIG. 5, mold insert 44 has a negative part geometry 38′. The space between the exemplary part geometry 38 of FIG. 4 and negative part geometry 38′ from FIG. 5 creates a void space that receives the material to make the final molded part. The mold housing top 40 also has within it formed mold insert pin channels 24.

FIG. 5A is a view of the mold insert 44 of FIG. 5, showing mold insert pin channels 24, conformal cooling channels 34 left by the production process, along with negative part geometry 38′ from FIG. 5. Unlike metal tooling, which requires complex CNC machining for features such as conformal cooling channels, this method allows such geometries to be printed directly into the mold cavity. This drastically reduces manufacturing time and cost while enabling enhanced thermal management. Conformal cooling channels 34 advantageously follow the shape of the part (note conformal cooling channels 34 of FIG. 5A wrap around exemplary part geometry 38) rather than cutting through it. Heretofore, this type of channel was extremely difficult and expensive to machine in metal due to geometric constraints but are easily integrated into 3D printed molds. These channels 34 significantly reduce cycle time by allowing the mold to cool more quickly and evenly after injection, reducing warping and improving part quality. However, most composite or printed molds do not survive long enough to take advantage of benefits of both conformal cooling and industrial-grade mold longevity.

Both mold housing top 40 and mold insert 44 (cavity side) are now created and ready for use in an injection molding setting, as shown in FIG. 6.

In total, this gradient-infused, centrifugally cast composite mold solution bridges the gap between short-run, low-strength additive molds and high-cost, high-durability steel tooling-delivering a mold that offers near-metal performance at a fraction of the price, with drastically reduced lead times and greater design flexibility.

Referring now to FIG. 6, in use, mold housing top 40 and mold insert 44 (not shown) are inserted into an injection mold base 51. In the illustrated embodiment, mold base 51 is shown for a two-plate injection molds, it being understood that the present invention is not limited to this arrangement. The mold base 51 advantageously allows for simple and quick swapping of mold inserts as described below

A two-plate injection mold is a common type used in plastic injection molding, consisting of two main halves: the stationary plate, which features the cavity that shapes the outer surface of the part, and the moving plate, which includes the core that forms the inner surface. In the illustrated embodiment, these components could be mold housing top 40 and cavity side mold insert 44 of FIGS. 4 and 5, respectively.

The process begins with clamping, where second main base 56 and main base 52 are slidably brought together via post 72 and its associated receiving port (not shown), and secured tightly in the injection molding machine to create a sealed cavity (not shown). Next, molten plastic material is heated in the machine's barrel (not shown) and injected under high pressure through a port in main base 52 (not shown), flowing into the mold cavity formed by the mold created as described above and placed within mold base 51, via runners and gates to fill the mold completely (not shown). Once injected into the mold, the plastic cools and solidifies inside the mold, adopting the shape of the cavity, with conformal cooling channels 34 cooling the temperature of the molded part for efficient hardening. After cooling, the mold opens by separating the second main base 56 and main base 52, and ejector pins carried by plates (described below in relation to FIGS. 6B-9) push the solidified part out of the mold for removal. The cycle then repeats as the mold closes again for the next injection.

In the embodiment shown in FIGS. 6-6A′, base plate 50 supports main base unit 52, through which mold base pins 62 are inserted. Connection circle 58 is carried by base plate 50. Eyebolts 54 are provided throughout the system, preferably threadably coupled to components carrying them. Their primary purpose is to provide a means by which to lift the mold components safely, and to assist in installing and removing the mold from the other molding equipment (not shown). Additionally, the eye bolts 54 can be used to rotate or orient the mold during set up or maintenance operations.

Second main base unit 56 carries posts 72. Not visible from the view shown in FIG. 6 are receptacles provided in main base 52 to host posts 72 in sliding engagement. Like main base 52, mold base pins 62 are slidably engaged through the second main base 56. Second main base 56 is preferably equipped with quick disconnect holes couplings 64, to which a supply of coolant (not shown) is coupled. The coolant is ultimately supplied through conformal channels 34 (see FIG. 5A as described above). Adjacent to second main base 56 is middle plate 66. Adjacent to middle plate 66 is an ejector base 68. An ejector comb 70 is slidably carried by and through ejector base 68 through a port in the side ejector base 68. A first ejector plate/ejector base 74 is also carried by ejector base 68. Adjacent to the first ejector plate 74 is a second ejector plate/ejector base cover 76. A third base plate 60 is carried distally from base plate 50

Referring now to FIG. 6A, a side view of the mold base assembly 51 of FIG. 6 is shown, with FIG. 6A′ a closeup view of portions thereof. Referring particularly to FIG. 6A′, ejector guide pins 78 are coupled to third base plate 60, and through the first ejector plate 74 and second ejector plate/ejector base cover 76, and ejector guide pins 78 are likewise carried through die springs 80.

Ejector pins 82 push the finished plastic part out of the mold 51 after the part has cooled and solidified. Once the main base 52 and second main base 56 separate following manufacture of a part, the ejector pins 82 are driven through pre-machined holes in the mold to release the part from the core side where the part may tend to stick.

Referring now to FIG. 6B, a side view of first ejector plate 74 and an associated comb structure 70 are shown. Referring to FIG. 6C, a second ejector plate 76 is provided, similarly formed to first ejector plate 74. Both first and second ejector plates 74 and 76 have a matrix of ejector base pin holes 84, and during operation ejector base pin holes 84 of each of the ejector plates 74 and 76 are aligned. In a preferred embodiment as shown in FIG. 6B′, ejector base pin holes 84 can be D-shaped to carry therethrough ejector pins 82 having a corresponding D-shaped cross section (see FIG. 7).

In use, a user decides where to position one or more ejector pins 82 to perform their ejection function against the produced part. In a preferred embodiment, a plurality of ejector base pin holes 84 on first ejector plate 74 serve as possible spots to position an ejector pin 82 through, depending on where a designer would like the ejector pins 82 to be deployed. An ejector pin 82 (see FIG. 7) is carried through one of a matrix of ejector base pin holes 84 on first ejector plate 74 (FIG. 6B), and through one of a second aligned matrix of ejector base pin holes 84 on second ejector plate 76 (FIG. 6C). The comb 70 is slid into the base and locks around detent 82′ on the bottom of an ejection pin 82 to retain ejector pin 82 in position relative to ejector plate 74.

Ejector comb 70 is slidably removably engaged through a sandwich of first ejector plate 74 and second ejector plate 76. Ejector comb teeth 88 are flexibly displaced about one or more ejector pins 82 in the sliding pathway of the teeth 88, and teeth 88 thus lock pins 82 into the chosen position within the aligned matrices of the first and second ejector plates 74 and 76 respectively. Comb teeth 88 act against the flat surface of the D-shaped cross section of ejector pins 82 to prevent rotation and displacement of ejector pins 82.

A user can grasp ejector comb handle 86, and slidably disengage ejector comb 70 from between first and second ejector plates 74 and 76 when pins 82 need to be moved, removed or changed. The comb 70 is slid into the ejector base side 68 and locks around detent 82′ on the bottom of an ejection pin 82.

During the ejection operation after the part is produced, the injection mold machine uses hydraulics (not shown) to push a distal surface of ejection base 74, first and second ejector plates 74 and 76, and ejector pin(s) 82 carried thereby, against the plastic part contained within the mold 51 (not shown) to eject the plastic part following its production.

As described above, the mold base 51 employs a precise pin system to ensure secure and accurate insertion of the mold inserts, alongside a modular ejector system that allows for customizable ejector pin configurations. This system enables users to adjust pin positions and quantities as needed, locking them in place with a comb mechanism. By enhancing flexibility, precision, and ease of use, this mold base significantly reduces downtime and complements the cost-effective, high-performance advantages of the cold-cast process.

Applications for these molds are ideally suited to medium-volume injection molding, particularly in industries such as automotive (e.g., HVAC vents, dashboard clips, bracket components), consumer electronics housings, packaging components, appliance parts, and small enclosures. These are part families that benefit from shorter development timelines and more frequent design iterations, without requiring multi-hundred-thousand-unit lifespans. A key advantage of this process is the ease of iteration: when design changes are required, the mold geometry can be quickly reprinted and recast with minimal labor, unlike traditional molds that require extensive re-machining or full rebuilds.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A method of forming a mold comprising:
providing a mold housing with a predetermined cavity shape;
at least partially filling said mold housing with a mixture of epoxy resin and at least one of a metal powder, carbon fiber, and ceramic particles to form an epoxy matrix;
subjecting said mold housing to centrifugal force, thereby inducing a material gradient within said epoxy matrix;
curing said epoxy matrix;
separating said mold housing from said cured epoxy matrix, said cured epoxy matrix forming said mold.

2. The method according to claim 1, said metal powder comprising particles of atomized stainless steel.

3. The method according to claim 1, said epoxy matrix comprising a hardener.

4. The method according to claim 3, said epoxy matrix comprising an amount of metal powder, an amount of epoxy resin less than said amount of metal powder, and an amount of said hardener less than said amount of said epoxy resin.

5. The method according to claim 1, said ceramic particles comprising zirconia powder.

6. The method according to claim 1, said ceramic particles comprising aluminum oxide powder.

7. A mold created by the method of claim 1.

8. A molded part ejection system comprising:
a first plate and a second plate, said first and second plates movable from a molding position at first separation distance, to an ejection position at a second separation distance, said separable plates forming a mold void for a molded part at said molding position;
an ejector base comprising a wall and an ejector plate void;
a first ejector plate comprising a first ejector pin void, said first ejector plate slidably positioned through said ejector plate void;
a second ejector plate comprising a second ejector pin void, said second ejector plate slidably positioned through said ejector plate void;
a comb slidably positioned between said first and second ejector plates;
a third plate carrying an ejector pin, said ejector pin comprising a distal end and a proximal end, said ejector pin slidably positioned through said first ejector pin void and said second ejector pin void, said distal end of said ejector pin slidable between said molding position and said ejection position.

9. The molded part ejection system according to claim 8, said first ejector plate comprising a plurality of spaced apart ejector pin voids.

10. The molded part ejection system according to claim 8, said second ejector plate comprising a plurality of spaced apart ejector pin voids.

11. The molded part ejection system according to claim 8, said first ejector pin void and said second ejector pin void aligned on an axis that said first and second plates are slidably movable.

12. The molded part ejection system according to claim 8, said first ejector pin void comprising a rounded portion and a flat portion.

13. The molded part ejection system according to claim 8, said second ejector pin void comprising a rounded portion and a flat portion.

14. The molded part ejection system according to claim 8, said comb comprising a handle and a plurality of teeth.

15. The molded part ejection system according to claim 4, a first and a second of said plurality of teeth positioned on opposite sides of said ejector pin.
